(19) United States
(12) Patent Application Publication
(10) Pub. No.: US 2011/0045780 A1
(43) Pub. Date: Feb. 24, 2011

(54) RADIO MEASUREMENT IN A RADIOCOMMUNICATIONS NETWORK

(75) Inventors: Afef Ben Hadj Alaya, Courbevoie (FR); Paul Houze, Ivry Sur Seine (FR); Sana Ben Jemaa, Issy Les Moulineaux (FR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: France Telecom, Paris (FR)

(21) Appl. No.: 12/672,747

(22) PCT Filed: Jul. 18, 2008
(86) PCT No.: PCT/FR2008/051365

§ 371 Date: Apr. 7, 2010

(30) Foreign Application Priority Data
Aug. 20, 2007 (FR) 0705915

(51) Int. Cl. H04W 24/00

(52) U.S. Cl. 455/67.11

(57) ABSTRACT

A radiocommunications network includes terminals and a network entity. The network entity determines at least one subset of network terminals on the basis of the distances between the terminals. A message is then sent to at least some of the terminals of said subset requesting them to effect a measurement. A value representing a capacity of a terminal to effect a measurement is associated with each terminal of the subset and the terminals that effect said measurement are determined on the basis of the respective values associated with them.

The present invention relates to measurements effected in a radiocommunications network.

Radio resource management in a radiocommunications network generally relies on radio measurements effected in the network. Such radio resource management may be more or less complex and require radio measurements of different types.

There can in particular be provision for managing interworking between different radiocommunications networks, for example managing roaming of a terminal from one network to another. Such interworking relies on radio resource management that can prove complex and is efficient only if it is based on pertinent radio measurements relating to the various networks concerned.

It should be noted that, quite apart from the complexity of such radio resource management, the number of radiocommunications network users is increasing. To satisfy them, it is therefore preferable to optimize the use of radio resources in the networks.

To this end, there can be provision for establishing an interference map for determining the level of interference at given times at precise geographical positions. From such interference levels it is then possible to determine the actual use that is made of the frequency spectrum at given times at precise geographical positions. Knowing the actual use of the frequency spectrum of a network, the use of the frequency spectrum can be optimized. Portions of this frequency spectrum that are not used by the terminals of a primary network at certain places at given times are therefore known. If use of those frequencies by the secondary network is deemed not to interfere with the primary network, it is then possible to use those portions to the benefit of terminals that may belong to a secondary radiocommunications network different from the primary network.

Such an interference map also enables detection of problems caused by propagation in the network concerned or detection of a network geographically adjacent the network concerned that is using the same or adjacent frequency bands.

Such measurements can be effected by the terminals in the network. There is thus provision for the mobile terminals belonging to a terrestrial mobile radio network such as a GSM (Global System for Mobile communications), UMTS (Universal Mobile Telecommunications system), EDGE (Enhanced Data rates for GSM Evolution) or WIMAX network to effect measurements periodically or in response to a predefined event in the network concerned.

A mobile terminal attached to a given network can also effect measurements on other networks geographically adjacent that to which it is attached. In particular, the given network can request this mobile terminal to effect measurements on an adjacent network in order to manage roaming between networks. The mobile terminal then measures a power level or estimates a quality level for the pilot channel of a plurality of base stations of the adjacent network in order to choose one of them as a potential target for possible roaming between networks.

Inter-network measurements can also be effected periodically, for example by mobile terminals in standby or idle mode that periodically compare the power level or the quality level of the pilot channel of the base station to which the mobile terminal is attached to that of adjacent base stations that can belong to another network.

However, effecting radio measurements in the terminals in a telecommunications network is costly. The consumption of energy by a mobile terminal is high while effecting the measurements.

Furthermore, the result of these measurements is sent by the terminals that effect them to the base stations of the network. Thus a high signaling load can sometimes be generated in the network.

The present invention aims to improve on the above situation.

A first aspect of the present invention proposes a measurement method in a radiocommunications network including terminals and a network entity, said method including the following steps executed by the network entity:

(a) determining at least one subset of network terminals on the basis of the distances between the terminals; and

(b) sending at least some of the terminals of said subset a message requesting them to effect a measurement; wherein a value representing a capacity of a terminal to effect a measurement is associated with each terminal of the subset and the terminals that effect said measurement are determined by comparing the respective values associated with them.

By means of these provisions, it is possible to effect pertinent and efficient measurements at the same time as limiting the problems caused by such measurements. Firstly, the global energy consumption of the terminals of the network is reduced because only some of the terminals of the network are responsible for effecting the measurement or measurements required. Second, the signaling load in the network caused by the terminals sending these measurements is reduced because fewer terminals send the results of these measurements to the network entity.

Furthermore, the measurements remain pertinent. The terminals that are to effect such measurements are geographically situated in a manner that is pertinent to effecting the measurement concerned because they all belong to a subset of terminals determined on the basis of the distances between the network terminals. Thus pertinent measured values can be obtained while limiting the number of terminals effecting such measurements.

In one implementation of the present invention, determining the terminals in the subset can be based on comparing capacity values associated with the terminals to a capacity threshold value. It should be noted here that in this situation terminals associated with values below the threshold value preferably do not effect measurements. Thus only terminals having a capacity value above the threshold value effect the required measurements.

Alternatively, this determination can be effected without using a capacity threshold value. For example, if N terminals in the subset are required to effect the measurements, then the terminals associated with the highest N values can effect the measurements. This implementation requires centralized management of the process of determining the terminals that are to effect the measurements.

The step of determining at least one subset of terminals can be carried out using a data partitioning method.

Thus to determine the subsets of terminals a data partitioning or clustering method can advantageously be used, as described in the 1999 document ‘Data Clustering: A Review’ by A. K. Jain, M. N. Murty, P. J. Flynn.

This makes it possible to determine subsets of network terminals that have some degree of homogeneity. The geographical proximity of the terminals results in homogeneous characteristics, for example homogeneous values of the radio measurements that they effect.

Such a measurement method can further include the following step between steps (a) and (b):

(i) selecting at least one terminal of said subset on the basis of the associated value(s);

wherein said message is sent to the selected terminal in step (b).

In such an implementation, the terminals that are to effect the measurements are selected at network entity level. The network entity then knows the respective capacity values associated with the terminals of the subset either from calculating them itself or by receiving them from said terminals. There can be provision for these values to be determined at network entity level or in the terminal itself.

In another implementation, there can be provision for the network entity simply to indicate a capacity threshold value to the terminals of the subset and for each of those terminals to decide whether to effect the required measurement as a function of the indicated threshold value.

Thus the message requesting that a measurement is effected indicates the capacity threshold value and the method includes the following steps effected at the terminal level:

(c) receiving a message requesting that a measurement be effected; and

(d) deciding to effect the requested measurement if the value associated with the terminal is above the capacity threshold value.

Furthermore, the method can further include the following step before the step of determining at least one subset of terminals:
determining at least one measurement geographical area in the radiocommunications network; and
the subset of terminals being determined from the terminals located in the geographical area so determined.

By proceeding in this way it is possible to determine a plurality of more or less relevant geographical areas as a function of the requirements of the network. Subsets of terminals can then be determined, preferably in the measurement geographical area or areas that are most relevant as a function of the measurement to be effected.

In this context, a priority level value represents the priority for effecting the measurements in a given geographical area. Such a value can be assigned to each of the geographical areas concerned and the step of determining at least one subset of terminals can furthermore be based on the priority level values of the measurement geographical areas.

Thus, according to one arrangement, the higher the priority level of a measurement geographical area, the higher the number of subsets in the particular measurement geographical area and/or the number of terminals selected.

If the selected terminals are adapted to effect a plurality of types of measurement, said method further includes the following step before the step of determining at least one subset of terminals:
identifying in said plurality of measurement types a type of measurement to be requested of the terminals.

In one implementation of the present invention, the distances between the terminals of the network are determined in the terminals and sent to the network entity.

Alternatively, the distances between the network terminals can be determined by the network entity on the basis of location information obtained, for example, by a satellite geographical positioning system or by application of a positioning method such as a time of arrival difference or triangulation method. Such a method can be executed either at the network entity level or externally of the network entity, in which event the network entity receives the location information.

The present invention is not limited in any way as to the manner used to determine the distances between the network terminals. A GSM (Global System for Mobile communications) positioning method based on an IMEI (International Mobile Equipment Identifier) can be used or, in a GSM network, cell-level identification based on a cell identifier. Principles analogous to those of the GSM can equally be applied in a UMTS (Universal Mobile Telecommunications System) network. IP (Internet Protocol) networks and Wi-Fi networks use positioning methods well known to the person skilled in the art that could be used advantageously in the context of an implementation of the present invention.

The value representing the capacity of a terminal expresses the aptitude of that terminal to effect measurements.

The present invention is not limited in any way as to the method used to determine a value representing such a capacity. The capacity of the terminal to effect a measurement can be determined in a centralized manner in the network by a network entity or by the terminal itself.

In the event of centralized determination of terminal capacity, a network entity determines that capacity as a function of data relating to the conditions appertaining to the terminal concerned, for example, which data can be sent by the terminal itself.

Having constructed subsets of terminals in this way and determined respective capacities for these terminals, the network entity can then select the terminals to effect the measurements.

In one implementation of the present invention, if the capacity of a terminal is determined by the terminal itself, that capacity is sent to the network entity that then selects the terminals that are to effect the measurements on the basis of that capacity.

Alternatively, instead of sending the capacity of the terminal to the network entity, the terminal can receive a message indicating a capacity threshold value above which it will effect the measurements concerned.

Thus the terminal is adapted to determine whether it is to effect the measurements on the basis of the capacity value that it has determined and information sent by the network. For example, the network sends terminals located in a particular geographical area the instruction to effect the measurements on condition that their capacities are above a certain threshold.

This capacity or aptitude to effect a measurement can depend on a multitude of parameters reflecting the operating conditions of the terminal concerned. For example, it can depend on an energy autonomy level of said terminal and/or a profile of the user of said terminal and/or propagation conditions at the location of said terminal.

The propagation conditions can in particular correspond to the distance between the terminal concerned and the network entity with which it is communicating.

A second aspect of the present invention proposes a measurement method in a radiocommunications network including at least one terminal, wherein a value representing a capacity of the terminal to effect a measurement is associated with said terminal, said method including the following steps executed by a terminal:

(a) receiving a message requesting that a measurement be effected, said message indicating a capacity threshold value; and

(b) deciding to effect the requested measurement if the value associated with the terminal is above the capacity threshold value.

A third aspect of the present invention proposes a network entity including means adapted to implement a measurement method according to the first aspect of the present invention.

A fourth aspect of the present invention proposes a terminal adapted to cooperate with the network entity according to the third aspect of the present invention.

The terminal may include a unit for determining a value representing the capacity of a terminal to effect a measurement.

A fifth aspect of the present invention proposes a network including at least one network entity according to the third aspect of the present invention and a plurality of terminals.

A sixth aspect of the present invention proposes a computer program for a network entity, including instructions adapted to execute the method according to the first aspect of the present invention when the program is executed by processing means of the network entity.

A seventh aspect of the present invention proposes a computer program for a terminal, including instructions for executing the method according to the second aspect of the present invention when the program is executed by processing means of the terminal.

Other aspects, aims and advantages of the invention become apparent on reading the description of an example of the invention.

The invention can also be better understood from the drawings, in which:

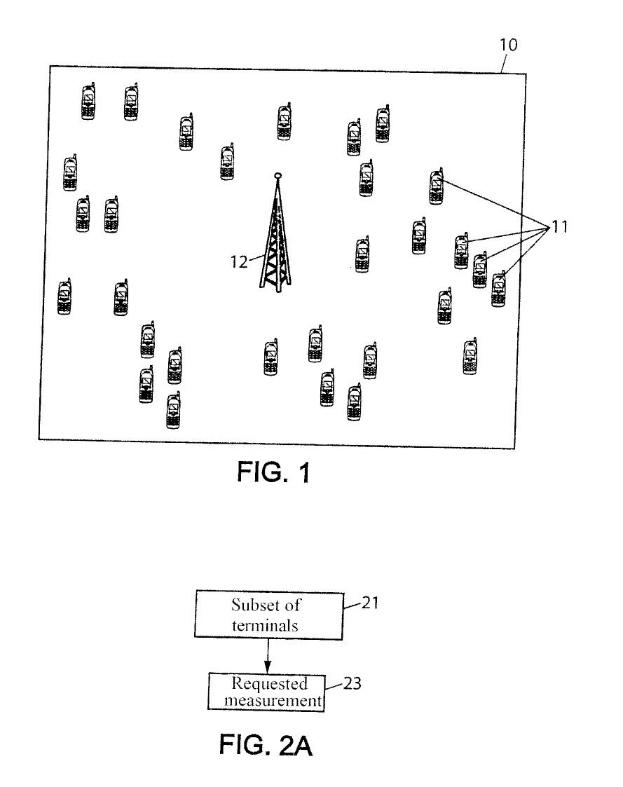

FIG. 1 shows a radiocommunications network of the present invention;

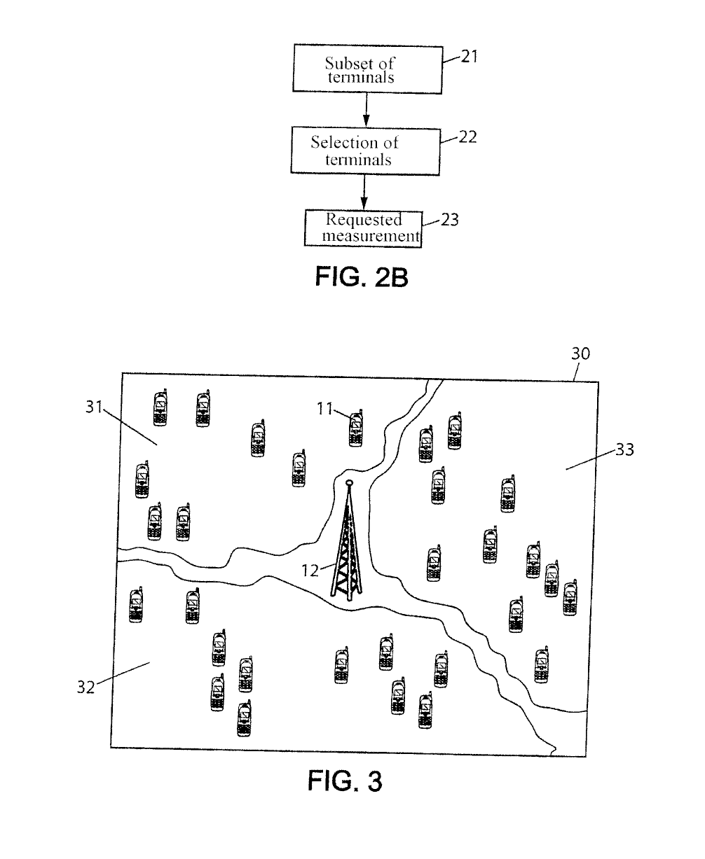

FIGS. 2-A and 2-B show the main steps of a measurement method of the present invention;

FIG. 3 shows a radiocommunications network of the present invention divided into measurement geographical areas;

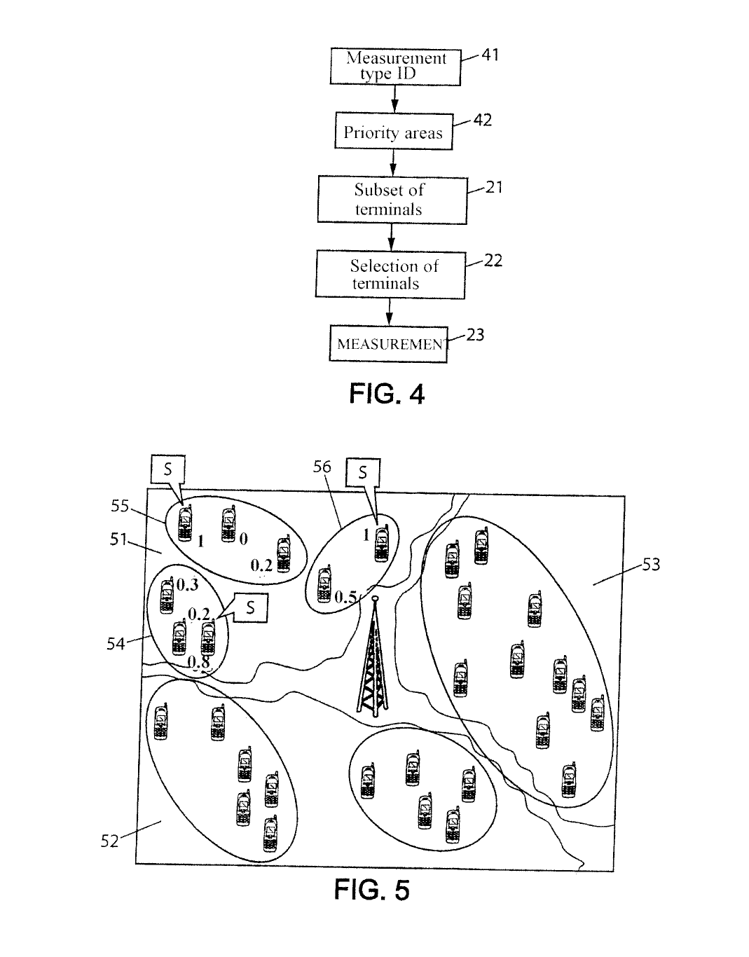

FIG. 4 shows the steps of another measurement method of the present invention;

FIG. 5 shows a radiocommunications network of the present invention in which capacity parameters are managed for terminals; and

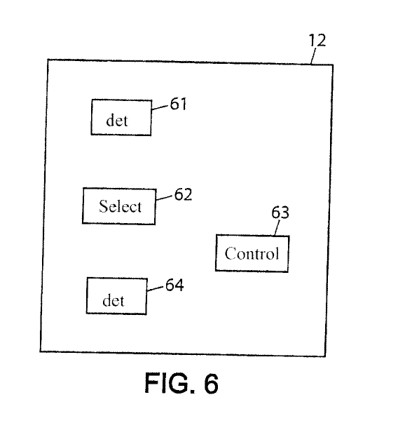

FIG. 6 shows a network entity of the present invention.

As used below the term “measurement” means a measurement relating to one or more radio resources in the network concerned and that can be effected in a terminal of a fixed or mobile radiocommunications network.

Such measurements can be of various types and the present invention is not limited as to the types of measurements. For example, these measurements can relate to the quality of a received signal or the occupancy or use of a frequency band.

FIG. 1 shows a radiocommunications network 10 of the present invention. This network is part of a mobile network and includes mobile terminals 11 and at least one base station 12. The mobile network of which this network 10 is part can of course include a plurality of base stations 12 interconnected by other central network entities.

In the context of the present invention, the term “network” is to be understood in a broad sense as meaning a set of equipment units that are interconnected in order to be able to exchange information. A network of the present invention includes a network entity responsible for selecting the terminals that will be requested to effect measurements.

For example, the type of radio measurement to be effected in the network shown in FIG. 1 relates to radio resource management with a view to optimizing the use of a band of frequencies if said band is not used by the terminals of the network concerned at some locations at some times.

In one implementation of the present invention the network 10 requires radio measurements for a given geographical area at a given time, which radio measurements provide it with information relating to the use of a frequency band between a frequency f₁ and a frequency f₂ inclusive, i.e. the frequency band [f₁, f₂].

FIG. 2-A shows the main steps of a measurement method of the present invention used in the network 10.

In a step 21, at least one subset of network terminals is determined on the basis of the distances between the terminals. Then, in a step 23, a message is sent to at least some of the terminals of said subset requesting that a measurement be effected.

The terminals associated with values above a capacity threshold value then effect the measurement.

In a centralized implementation of the present invention, a network entity knows capacity values associated with the terminals of the subset and selects the terminals that will be requested to effect the measurement on the basis of those values. This selection can be based on comparing capacity values assigned to the terminals with a threshold value.

In a decentralized implementation of the present invention, the network entity can send a message to all the terminals of the subset. Each terminal then decides whether to effect the measurement or not by comparing its capacity value with the capacity threshold value indicated in the message received from the network entity.

FIG. 2-B shows the main steps of a measurement method conforming to a centralized implementation of the present invention used in the network 10.

In a step 21, a subset of the terminals included in or attached to the network 10 is determined. This step can be effected in an entity of the network concerned, which can in particular correspond to a base station 12 in the network 10.

Nevertheless, the present invention is not limited as to the type of network entity 12 for determining this subset of terminals in the network. It can be the only one in the network concerned or the determination of the subsets can be distributed between a plurality of entities in the network as a function of the architecture of the network or the geographical positions of the terminals in the network.

This step of determining subsets of terminals can advantageously be based on the geographical positions of the terminals or to be more precise the distances between the terminals 11 in the network 10.

A static analysis can be carried out in relation to the terminals in order to form subsets of terminals having common properties. A method of clustering data taking into account the distances between the terminals can be used.

Data clustering is a static data analysis method that generally groups a set of data into different homogeneous data groups. A data group is considered homogeneous if the data of the group shares common characteristics.

In the context of using such a clustering method in an implementation of the present invention, a homogeneous subset of terminals can be defined on the basis of characteristics relating to their geographical position, and more particularly as a function of the distances between the terminals. Thus the homogeneity of a subset of terminals can be founded on their geographical proximity because, the closer the terminals geographically, the closer the values produced by the radio measurements effected.

Then, in a step 22, and in either a centralized or a distributed manner, the network selects from the subset of terminals so determined the terminals that will be requested to effect the radio measurements.

Such selection aims to produce pertinent radio measurement values (addressing the radio measurement requirements of the network) and to reduce the number of terminals effecting the radio measurements.

To this end, this selection step can advantageously be based on the capacity of the terminals of the subset to effect the required measurements, in order to select those that are the best suited to effect the measurement. Each of the terminals can be assigned a value of a parameter that represents a capacity to effect the measurement. Such a parameter value can be determined by the terminal or by the network entity.

In a step 23, the selected terminals are requested to effect the radio measurement. Thus it is the selected terminals that effect the radio measurement, which has the advantage that the other terminals are relieved of effecting the radio measurement. This feature reduces signaling traffic in the network 10 and overall energy consumption in the network.

In a radiocommunications network such as that partially shown in FIG. 1, a base station 12 is responsible for a set of N mobile terminals {M_{k}}_{1≦k≦N} where k is an integer between 0 and N inclusive.

In one implementation of the present invention, the base station holds geographical position information relating to the N mobile terminals for which it is responsible. The base station can produce such position information using various methods.

Thus it is possible in particular to use a satellite geographical positioning system like the GPS (Global Positioning System).

The base station 12 can equally be adapted to effect geographical positioning by the TDOA (Time Difference Of Arrival) method, for example.

The geographical position of the terminal {M_{k}}_{1≦k≦N} is denoted (xₖ, yₖ).

Starting with the geographical positions of the network terminals, the base station 12 is then able to deduce the distances between the terminals.

It is a simple matter to derive from the above implementation another implementation in which it is the terminals 11 themselves that determine the distances that separate them from other adjacent terminals in the network.

In an implementation of the present invention requiring an interference map relating to the network, the base station 12 requires radio measurements fed back by the terminals 11 that cover the geographical area for which it is responsible. In the example considered here these radio measurements relate to the use of a band adjacent the band [f₁, f₂].

It should be noted that for some types of measurement a geographical position may be of greater or lesser benefit for effecting the measurement at a time t.

For example, it can be very important to know the occupancy of the band [f₁, f₂] at a geographical position (x₀, y₀) at a time t although the occupancy of this same band at another geographical position (x₁, y₁) is less useful for managing the network at this time t.

The utility or pertinence of effecting a measurement at a given location in the network can be represented by a parameter representing a priority or pertinence parameter.

In one implementation of the present invention, the network 10 has a geographical coverage that extends over a global geographical area 30 around the base station 12 as shown in FIG. 3.

To take into account the pertinence of the geographical positions of the terminals of the network, this global geographical area 30 can advantageously be divided into a plurality of measurement geographical areas having different priority levels.

Thus a number L of different priority levels in the network concerned is defined, and a parameter {iₗ}_{1≦l≦L} represents a priority level relating to effecting a measurement in the network. The higher the value of this parameter, the more pertinent is the measurement geographical area with which it is associated to the measurement to be effected for the network.

FIG. 3 shows an example of defining measurement geographical areas 31, 32, and 33 of the network assigned respective priority levels i₁, i₂, and i₃, the value i₁ representing the highest priority geographical area and the value i₃ representing the lowest priority geographical area.

Under these conditions, at a given time t, it is more pertinent to effect the required measurement in the measurement geographical area 31 than in the measurement geographical areas 32 and 33.

It should be noted that it can be advantageous to make provision for effecting a greater number of measurements in geographical areas assigned higher priority levels.

In each measurement geographical area, subsets of the terminals located in the measurement geographical area concerned are determined. Some of the terminals in each subset are then selected in order to request them to perform the required measurement.

To this end, a static analysis is carried out in relation to the terminals located in each measurement geographical area in order to form subsets of terminals having common properties. This can be done using a data clustering method taking into account the distances between the terminals in the geographical area concerned.

In the context of an implementation of the present invention using such a clustering method, a homogeneous subset of terminals can be defined on the basis of characteristics relating to their geographical position, and more particularly as a function of the distances between the terminals. Thus the homogeneity of a subset of terminals can be based on their geographical proximity since, the geographically closer the terminals, the closer the values of the radio measurements effected.

The clustering can be effected as a function of the measurement geographical area of the network to which a terminal belongs at a time t. More or less refined clustering is obtained, as a function of the priority level associated with the measurement geographical area. Thus it can be advantageous to provide for highly refined clustering in a measurement geographical area having a high priority level in order to obtain a higher number of subsets of terminals in that area than in other areas having a lower priority level.

Under these conditions, the number of terminals finally selected to effect the measurements can be higher in an area having a high priority level than in an area having a lower priority level.

Moreover, in one implementation of the present invention, each terminal is assigned a value to represent its capacity to effect a given type of measurement.

This capacity value can depend on the charge state of its battery, for example. It is preferable for a terminal having a charged battery to effect measurements rather than a terminal having a low energy autonomy.

This capacity value can equally depend on the propagation conditions in which the terminal concerned finds itself. It is preferable for measurements to be effected by a terminal that is close to the base station

This capacity value can further depend on the profile of the user of the terminal, for example certain characteristics of their subscription agreement with the network operator.

The capacity values can vary dynamically over time and can be a function of the type of measurement required. There is no limitation as to the method used and the characteristics taken into account to determine these capacity values for the terminals.

It is then advantageous for a terminal having a higher capacity value than another terminal to have a greater chance of being chosen by the network to effect the required measurements. The capacity parameter pₖ can be a number between 0 and 1 inclusive where k is an integer between 1 and the number of terminals in the subset concerned.

Thus for a capacity parameter value equal to 0, the terminal is not predisposed to effect the measurements. Conversely, for a value equal to 1, the terminal is considered able to effect the measurement. The expression {S_{d,l}}_{1≦l≦L} designates a d^{th} subset in a measurement geographical area having a priority level I, where d is an integer between 1 and the number of terminals in the measurement geographical area inclusive and l is a number between 1 and a value L inclusive. The expression {pₖ}_{1≦k≦N} designates the capacity parameter representing the capacity or aptitude of the terminal Mₖ to effect the measurements.

Then, in each subset S_{d,l}, the values of the capacity parameter pₖ assigned to the terminals Mₖ can be classified in increasing order, for example. The network can then choose the most suitable terminals and request them to effect the measurements.

FIG. 4 summarizes the steps of a method of the present invention in which a geographical area of the network concerned is divided into a plurality of measurement geographical areas.

Thus a step 41 determines the type of measurement to be effected at a time t. Then, as a function of the type of measurement to be effected, a step 42 defins a plurality of measurement geographical areas by assigning them values reflecting their priority level relative to the measurement to be effected.

Then, in a step 21, and as described with reference to FIG. 2, subsets of terminals are formed in each of the measurement geographical areas using a statistical method such as a data clustering method based on the distances between the terminals of the measurement geographical area concerned. Then only some of the terminals in each of the subsets of terminals are selected for carrying out a measurement, as a function of the capacity of each of the terminals. Then, in the step 23, the terminals selected in step 22 are requested to effect the measurement.

This method produces highly pertinent measurements at a given time t. In a mobile radiocommunications network, it would appear advantageous to iterate this method and to select again the terminals best suited to effect the required measurements. Under these conditions, assuming that the terminals are moving, and even for the same type of measurement, the pertinence of a geographical area is not the same at different measurement times (and likewise the radio measurement requirements of the network).

In one implementation of the present invention, a measurement method of this kind is used in the context of use by a secondary network of frequency bands that are not used by the primary network. A secondary network terminal can then use a given frequency band normally assigned to the primary network if the primary network is not using it. Conversely, it is preferable, as soon as a primary network terminal requires to use this frequency band, for the secondary network terminal using it to be responsible for releasing it. Such a frequency band can be the 470-830 MHz broadcast band, for example. This resource management can be founded on measurements relating to the frequency band concerned. Here it can be advantageous to use a method of the present invention.

FIG. 5 shows a network including terminals of subsets of terminals of measurement geographical areas. To be more precise, three measurement geographical areas 51, 52, and 53 are shown here having respective priority levels i₁, i₂, and i₃. The measurement geographical area 51 having the highest priority level i₁, this geographical area is preferred for measuring the use of the frequency band [f₁, f₂] therein in order to determine whether this frequency band is free or not.

The network then proceeds to the step 21 of determining homogeneous subsets of terminals by applying in the measurement geographical area 51 having a priority level i₁ a data clustering method based on the geographical positions of the terminals concerned in the geographical area 51.

Three subsets 54, 55, and 56 of terminals are determined in the measurement geographical area 51 having priority level i₁.

The network selects one or more terminals in each of these subsets 54 to 56 as a function of its capacity to effect the required measurement.

The subset 54 comprises one terminal having a capacity parameter equal to 0.2, another terminal having a capacity parameter equal to 0.3, and a further terminal having a capacity parameter equal to 0.8.

The subset 55 comprises one terminal having a capacity parameter equal to 0, another terminal having a capacity parameter equal to 0.2, and a further terminal having a capacity parameter equal to 1.

The subset 56 comprises one terminal having a capacity parameter equal to 0.5 and another terminal having a capacity parameter equal to 1.

Thus the network is able to select the terminals in each subset that are best suited to effect the measurements on the basis of the values of these capacity parameters.

The network then sends the selected terminals an instruction to effect the measurement.

This instruction or request message advantageously specifies the type of measurement to be effected and where appropriate the frequency band to be measured. Other information can also be given in this message. For example, the message can indicate if the terminal is to process measurements before sending them to the network. These terminals thus effect the measurements required by the network and return to the network a measurement report containing values relating to those measurements or, more generally, the information requested by the network.

The terminals selected to measure the occupancy of the band [f₁, f₂] are indicated by the reference s in FIG. 5. Thus five mobile terminals are relieved of effecting measurements in the area having a priority level i₁ and only three mobile terminals effect the measurements in that area.

FIG. 6 shows a network entity 12 of one embodiment of the present invention including a unit 61 adapted to determine at least one subset of network terminals on the basis of the distances between the terminals. It also includes a control unit 63 adapted to request at least some of the terminals of said subset to effect the measurement. In one embodiment of the present invention, it also includes a selection unit 62 adapted to select at least one terminal from the subset of terminals on the basis of values associated with said terminals representing the respective capacities of the terminals to effect a measurement. The control unit 63 can then be adapted to request said selected terminal or terminals to effect the measurement.

The determination unit 61 can also be adapted to implement a data clustering method.

This determination unit 61 can further be adapted to determine at least one measurement geographical area in the radiocommunications network, the subset of terminals being determined from the terminals located in the geographical area so determined.

It can further be adapted to assign measurement geographical areas respective priority levels for effecting the measurement and to base the determination of at least one subset of terminals on said priority levels of the measurement geographical areas.

This network entity can furthermore comprise a unit 64 adapted to determine the distances between the network terminals on the basis of location information obtained from a satellite geographical position system, for example, or by applying a time of arrival difference method.

1-16. (canceled)

17. A measurement method in a radiocommunications network including terminals and a network entity, said method comprising the following steps executed by the network entity:
(a) determining at least one subset of network terminals on the basis of the distances between the terminals, wherein a value representing a capacity of a terminal to effect a measurement is associated with each terminal of the subset, and selecting at least one terminal of said subset by comparing the respective values associated with each terminal and a capacity threshold value; and
(b) sending said at least one terminal of said subset a message requesting it to effect said measurement.

18. A measurement method according to claim 17 further comprising the following step before the step of determining at least one subset of terminals:
determining at least one measurement geographical area in the radiocommunications network; and
the subset of terminals being determined from the terminals located in the geographical area so determined.

19. A measurement method according to claim 18, wherein respective priority levels for effecting the measurement are assigned to measurement geographical areas and the step of determining at last one subset of terminals is further based on the priority levels of the measurement geographical areas.

20. A measurement method according to claim 19, wherein the higher the priority level of a measurement geographical area, the higher the number of subsets in the particular measurement geographical area and/or the number of terminals effecting the measurement.

21. A measurement method according to claim 17, wherein the terminals are adapted to effect a plurality of types of measurement, said method further comprising the following step before the step of determining at least one subset of terminals:
identifying in said plurality of measurement types a type of measurement to be requested of the terminals.

22. A measurement method according to claim 17, wherein the value representing the capacity of a terminal is a function of at least one of:
an energy autonomy level of said terminal;
a profile of the user of said terminal; and
propagation conditions at the location of said terminal.

23. A network entity in a radiocommunications network further comprising terminals, said network entity comprising:
a determination unit adapted to determine at least one subset of network terminals on the basis of the distances between the terminals;
a selection unit adapted to select at least one terminal of the subset on the basis of values associated with said terminals representing the respective capacities of the terminals to effect a measurement, and
a control unit adapted to request said at least one selected terminal of said subset to effect the measurement.

24. A network entity according to claim 23, wherein the determination unit is further adapted to determine at least one measurement geographical area in the radiocommunications network, the subset of terminals being determined from the terminals located in the geographical area so determined.

25. A network entity according to claim 24, wherein the determination unit is further adapted to assign priority levels for effecting the measurement to respective measurement geographical areas and to base determining at least one subset of terminals on said priority levels of the measurement geographical areas.

26. A radiocommunications network comprising at least one network entity according to claim 23 and a plurality of terminals.

27. A computer program for a network entity, comprising instructions adapted to execute the method according to claim 17 when the program is executed by processing means of said network entity.
